(19) United States
(12) Patent Application Publication
(10) Pub. No.: US 2019/0202385 A1
(43) Pub. Date: Jul. 4, 2019

(54) SUPERCAPACITOR CHARGE SYSTEM AND METHOD

(71) Applicant: E-SYNERGY GRAPHENE RESEARCH PTE. LTD., Singapore (SG)

(72) Inventors: Kok Onn LO, Penang (MY); Eng Kiat CHEN, Singapore (SG)

(73) Assignee: E-SYNERGY GRAPHENE RESEARCH PTE. LTD., Singapore (SG)

(21) Appl. No.: 16/331,528

(22) PCT Filed: Aug. 8, 2017
(86) PCT No.: PCT/SG2017/050398

§ 371 Date: Mar. 8, 2019

(30) Foreign Application Priority Data
Sep. 9, 2016 (SG) 10201607549Q

(51) Int. Cl. B60R 16/033; H02J 7/00; H02J 7/34

(52) U.S. Cl. CPC B60R 16/033; H02J 7/0029; H02J 7/0045; H02J 2007/0049; H02J 7/345; H02J 2007/0037; H02J 7/0047

(57) ABSTRACT

The present invention relates to a supercapacitor charge system and a supercapacitor charge method of the supercapacitor charge system for a vehicle. The system and method are particularly relevant, but not limited to at least one supercapacitor, a stabilization and equalization controller operable to dampen a noise voltage, a charge balancing controller operable to supress an overcharge of the at least one supercapacitor, and an energy management controller operable to control charge and discharge of the at least one supercapacitor for an energy distribution and operable to manage the energy distribution by interfacing with the stabilization and equalization controller and the charge balancing controller. Further, the system and method are particularly relevant, but not limited to the energy management controller that is operable to detect a charge amount and determine whether to charge or stop charging based on the charge amount.

### FIELD OF INVENTION

The present invention relates to a supercapacitor charge system and a supercapacitor charge method of the supercapacitor charge system for a vehicle. The system and method are particularly relevant to replace a non-environmental friendly battery of the vehicle.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Conventionally, vehicles such as automobiles have used one or more non-environmental friendly batteries, for example lead acid batteries, as electrical energy storage for supply of power to the vehicle. The lead acid battery is able to supply electrical energy required for engine start up, supply the electrical energy to the vehicle electrical system when an engine is stopped or a generator breaks down, and adjust a temporal disparity between an output and a load of the generator by converting the electrical energy to chemical energy, storing it and discharging it when necessary.

Particularly, the lead acid battery is able to supply high electrical voltage and current required for the starting up and/or operation of the automobile. In other words, the lead acid battery has a relatively large power-to-weight ratio with low cost. Therefore, the lead acid battery is attractive for use in the vehicles to provide the high current required by starter motors.

However, the lead acid battery has a disadvantage that it is non-environmental friendly battery. Overtime, electrodes of the lead acid battery may also degenerate and hence the output current produced will no longer meet the necessary requirement. Some lead compounds of the lead acid battery are extremely toxic. Further, long-term exposure to even tiny amounts of these compounds can cause brain and kidney damage, hearing impairment and learning problems in people.

As such, there exists a need for an improved system and/or battery that is able to alleviate the aforementioned drawbacks at least in part.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The present invention seeks to replace a non-environmental friendly battery of a vehicle with an environmental friendly battery. In addition, the present invention seeks to optimize the control of charge and discharge cycles of the environmental friendly battery.

In accordance with first aspect of the present invention there is a supercapacitor charge system for a vehicle comprising: at least one supercapacitor; a stabilization and equalization controller operable to dampen a noise voltage; a charge balancing controller operable to supress an overcharge of the at least one supercapacitor; and an energy management controller operable to control charge and discharge of the at least one supercapacitor for an energy distribution and operable to manage the energy distribution by interfacing with the stabilization and equalization controller and the charge balancing controller, and wherein the energy management controller is operable to detect a charge amount and determine whether to charge or stop charging based on the charge amount.

Preferably, the at least one supercapacitor is diffused with graphene onto an active carbon film.

Preferably, diffusing of the graphene into an activated carbon anode is to lower a resistance of an electrical series resistors (ESR).

Preferably, the at least one supercapacitor is integrated with the charge balancing controller.

Preferably, the supercapacitor charge system further comprises a storage medium operable to store buffer energy.

Preferably, the storage medium includes a lithium iron phosphate medium.

Preferably, the stabilization and equalization controller is operable to dampen the noise voltage which comes from at least one of the following: an alternator, a generator, a magneto and an ignition system.

Preferably, the stabilization and equalization controller comprises a plurality of capacitors and a resistor.

Preferably, the charge balancing controller comprises, in series between each cell, a light emitting diode (LED) and a Zener diode.

Preferably, the LED lights up when the corresponding supercapacitor is fully charged up.

Preferably, the supercapacitor charge system further comprises a kinetic energy recovery system (KERS) connected as an external media and operable to capture a kinetic energy under braking.

Preferably, the energy management controller is operable to manage the energy distribution by interfacing with the KERS.

Preferably, the KERS is operable to convert the kinetic energy to an electrical energy and transfer the converted energy in at least one of the supercapacitor and the storage medium.

Preferably, the KERS is operable to power up the supercapacitor charge system so that the supercapacitor charge system can supply power to the vehicle.

Preferably, the supercapacitor charge system further comprises an external charger connected as an external media and including an induction coil motor.

Preferably, the external charger includes at least one of the following: an alternator, a generator and a charger.

Preferably, the alternator is operable to power up the supercapacitor charge system so that the supercapacitor charge system can supply power to the vehicle.

Preferably, the energy management controller is operable to control charge and discharge of the storage medium for the energy distribution.

Preferably, the energy management controller is operable to discharge the storage medium in order to charge the at least one supercapacitor.

Preferably, the energy management controller is operable to determine to charge one of the supercapacitor and the storage medium if the charge amount is below a predetermined amount.

Preferably, the energy management controller is operable to be synchronized with the stabilization and equalization controller.

Preferably, the energy management controller is operable to compute a Fourier transform line integration formulation at a pre-set interval to optimize the charge and discharge of the at least one supercapacitor and the storage medium.

Preferably, the energy management controller is operable to compute the Fourier transform line integration formulation at every 11 ns.

Preferably, the energy management controller is operable to compute a numerical integration formulation to optimize the charge and discharge of the at least one supercapacitor and the storage medium.

Preferably, the energy management controller comprises a plurality of capacitors, a plurality of registers, a diode, an inductor and an algorithm firmware modem.

Preferably, the algorithm firmware modem is a programmable chip and is operable to support electronic components.

Preferably, the algorithm firmware modem is operable to trigger different charge and discharge output quantum level in a real dynamic mode in order to manage the energy distribution.

Preferably, if the vehicle is a car, the storage medium provides a first initial charge to the supercapacitor, and the alternator provides power to the supercapacitor to run the car.

Preferably, if the vehicle is a forklift, the charger charges the storage medium, and the storage medium provides power to the supercapacitor to run the forklift.

In accordance with second aspect of the present invention there is a supercapacitor charge method of a supercapacitor charge system for a vehicle comprising: dampening a noise voltage at a stabilization and equalization controller; supressing, at a charge balancing controller, an overcharge of at least one supercapacitor; controlling, at an energy management controller, charge and discharge of the at least one supercapacitor for an energy distribution; and managing, at the energy management controller, the energy distribution by interfacing with the stabilization and equalization controller and the charge balancing controller, and wherein the energy management controller is operable to detect a charge amount and determine whether to charge or stop charging based on the charge amount.

Preferably, the at least one supercapacitor is diffused with graphene onto an active carbon film.

Preferably, diffusing of the graphene into an activated carbon anode is to lower a resistance of an electrical series resistors (ESR).

Preferably, the at least one supercapacitor is integrated with the charge balancing controller.

Preferably, the supercapacitor charge system further comprises a storage medium operable to store buffer energy.

Preferably, the storage medium includes a lithium iron phosphate medium.

Preferably, the stabilization and equalization controller is operable to dampen the noise voltage which comes from at least one of the following: an alternator, a generator, a magneto and an ignition system.

Preferably, the stabilization and equalization controller comprises a plurality of capacitors and a resistor.

Preferably, the charge balancing controller comprises, in series between each cell, a light emitting diode (LED) and a Zener diode.

Preferably, the LED lights up when the corresponding supercapacitor is fully charged up.

Preferably, the supercapacitor charge method further comprises a kinetic energy recovery system (KERS) connected as an external media and operable to capture a kinetic energy under braking.

Preferably, the energy management controller is operable to manage the energy distribution by interfacing with the KERS.

Preferably, the KERS is operable to convert the kinetic energy to an electrical energy and transfer the converted energy in at least one of the supercapacitor and the storage medium.

Preferably, the KERS is operable to power up the supercapacitor charge system so that the supercapacitor charge system can supply power to the vehicle.

Preferably, the supercapacitor charge method further comprises an external charger connected as an external media and including an induction coil motor.

Preferably, the external charger includes at least one of the following: an alternator, a generator and a charger.

Preferably, the alternator is operable to power up the supercapacitor charge system so that the supercapacitor charge system can supply power to the vehicle.

Preferably, the energy management controller is operable to control charge and discharge of the storage medium for the energy distribution.

Preferably, the energy management controller is operable to discharge the storage medium in order to charge the at least one supercapacitor.

Preferably, the energy management controller is operable to determine to charge one of the supercapacitor and the storage medium if the charge amount is below a predetermined amount.

Preferably, the energy management controller is operable to be synchronized with the stabilization and equalization controller.

Preferably, the energy management controller is operable to compute a Fourier transform line integration formulation at a pre-set interval to optimize the charge and discharge of the at least one supercapacitor and the storage medium.

Preferably, the energy management controller is operable to compute the Fourier transform line integration formulation at every 11 ns.

Preferably, the energy management controller is operable to compute a numerical integration formulation to optimize the charge and discharge of the at least one supercapacitor and the storage medium.

Preferably, the energy management controller comprises a plurality of capacitors, a plurality of registers, a diode, an inductor and an algorithm firmware modem.

Preferably, the algorithm firmware modem is a programmable chip and is operable to support electronic components.

Preferably, the algorithm firmware modem is operable to trigger different charge and discharge output quantum level in a real dynamic mode in order to manage the energy distribution.

Preferably, if the vehicle is a car, the storage medium provides a first initial charge to the supercapacitor, and the alternator provides power to the supercapacitor to run the car.

Preferably, if the vehicle is a forklift, the charger charges the storage medium, and the storage medium provides power to the supercapacitor to run the forklift.

Other aspects of the invention will become apparent to those of ordinary skill in the art upon review of the following description of specific embodiments of the invention in conjunction with the accompanying figures or by combining the various aspects of invention as described above.

### BRIEF DESCRIPTION OF THE DRAWINGS

The present invention will now be described, by way of example only, with reference to the accompanying drawings, in which:

FIG. 1 illustrates a block diagram of a supercapacitor charge system in accordance with an embodiment of the invention.

FIG. 2 illustrates a flow diagram of a supercapacitor charge method in accordance with an embodiment of the invention.

FIG. 3 illustrates a schematic diagram of a supercapacitor charge system in accordance with an embodiment of the invention.

FIG. 4 illustrates a table showing values of circuitry component illustrated in FIG. 3 in accordance with an embodiment of the invention.

FIG. 5 illustrates an example of a supercapacitor charge system in accordance with an embodiment of the invention.

FIG. 6 illustrates a modular layout of a supercapacitor charge system in accordance with an embodiment of the invention.

FIGS. 7 and 8 illustrate examples of a practical application of a supercapacitor charge system in accordance with an embodiment of the invention.

FIG. 9 illustrates a table showing advantages of a supercapacitor charge system in accordance with an embodiment of the invention compared with conventional batteries.

FIGS. 10 to 13 illustrate line graphs showing torque and power output from the supercapacitor charge system and method compared with a conventional battery.

FIG. 14 illustrates line graphs showing air fuel ratio and power output from the supercapacitor charge system and method compared with a conventional battery.

### DESCRIPTION OF EMBODIMENTS OF THE INVENTION

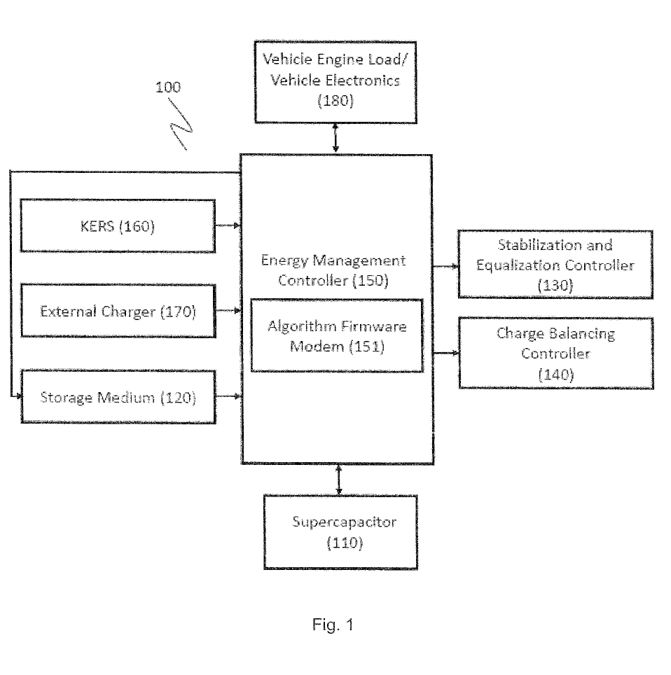

FIG. 1 illustrates a block diagram of a supercapacitor charge system 100 for a vehicle in accordance with an embodiment of the invention.

The supercapacitor charge system 100 may be a subset of a high kinetic discharge system. The supercapacitor charge system 100 includes at least one supercapacitor 110 as an immediate main energy peripheral reservoir, a stabilization and equalization controller 130, a charge balancing controller 140 and an energy management controller 150.

Although not shown, the supercapacitor charge system 100 may include six (6) supercapacitors 110. Meanwhile, the number of the supercapacitor 110 may depend on a type of vehicle. Although not shown, the supercapacitor 110 is integrated with the charge balancing controller 140. In various embodiments, where output power requirement is higher, the number of supercapacitors 110 may be more than six. In other embodiments, the number of supercapacitors 110 may be less than six.

A capacitor is an energy storage medium similar to an electrochemical battery. A supercapacitor is a high-capacity capacitor with capacitance values much higher than a typical capacitor of the same size. The supercapacitor 110, also known as an ultra-capacitor, is therefore suitable as a replacement for electrochemical batteries in industrial and commercial applications. To be suitable for such industrial and commercial applications, control of the supercapacitor 110 has to be managed precisely. In particular, the charge and discharge cycle is managed by the energy management controller 150.

The supercapacitor 110 may be doped with graphene. In some embodiments, doping is achieved by diffusing the supercapacitor 110 with graphene. For example, the supercapacitor 110 is diffused with 3% to 10% of fine graphene mesh material onto an active carbon film. It is understood that the embodiments are not limited to the above range and the above mesh material, as such, other range of graphene diffusion such as 1% to 15%, 2% to 8% may be possible.

Graphene is, basically, a single atomic layer of graphite. The graphene is an allotrope of carbon that is made up of very tightly bonded carbon atoms organized into a hexagonal lattice. The graphene has the Sp² hybridisation and very thin atomic thickness (0.345 nm). These properties are what enable the graphene to break records in terms of strength, electricity and heat conduction. In this regard, the graphene diffused supercapacitor 110 has a high energy storage capability due to a high porosity of graphene nanostructure to achieve a high surface area for a high energy density storage. In addition, the graphene diffused supercapacitor 110 has a low temperature operation and is capable of delivering energy down to −40° C. with minimum effect on efficiency.

As an example, the doping of the graphene mesh into an activated carbon anode is able to alter an electrical property, in particular lowering the resistance of an electrical series resistors (‘ESR’) so that electron holes pairs mobility charge carriers in an electrolyte embedded region of the supercapacitor 110 can travel at high velocity rate. Such a feature provides fast charge and discharge through an absorption and release of an ion composition. In other words, due to extremely low resistivity properties of the graphene, it is allowed to discharge onto any external load and the storage medium 120 as a buffer energy storage to top up the graphene diffused supercapacitor 110 which has rapid charge capabilities.

The supercapacitor charge system 100 further includes a storage medium 120 as a buffer energy reservoir. The storage medium 120 may be a redox battery. One example of the storage medium 120 is a lithium iron phosphate (LiFePO₄) medium and one example of the buffer energy is electrical energy. It is understood that the storage medium 120 is not limited to the lithium iron phosphate medium but can include other forms of batteries suitable for use in the start-up and provision of electrical energy or other energy to a vehicle. In addition, it is understood that the buffer energy is not limited to the electrical energy but can include other forms of energy such as chemical energy.

The functions of the storage medium 120 and an external charger 170 can vary depending on the type of vehicle. For example, where the supercapacitor charge system 100 is installed in a car, the main source of an input charge comes from the external charger 170, for example alternator. The storage medium 120, for example lithium iron phosphate medium, provides a first initial charge to the supercapacitor 110.

In another embodiment where the supercapacitor charge system 100 is installed in a forklift, the external charger 170, for example charger, charges the storage medium 120, for example lithium iron phosphate medium, and the storage medium 120 may be the main source to provide electrical power to the supercapacitor 110 to run the forklift.

The energy management controller 150 controls charge and discharge of the supercapacitor 110 and the storage medium 120 for an energy distribution. To control them, the energy management controller 150 is interfaced with the supercapacitor 110 and the storage medium 120.

In some embodiments, the energy management controller 150 is operable to discharge the storage medium 120 in order to charge the supercapacitor 110 having rapid charge capability. In addition, the energy management controller 150 detects a charge amount and determine whether to charge or stop charging based on the charge amount. The charge amount includes at least one of a charge amount of the storage medium 120 and a charge amount of the supercapacitor 110.

For example, the energy management controller 150 may detect a charge amount of the storage medium 120. If the charge amount is below a predetermined amount, the energy management controller 150 operates to charge the storage medium 120. Meanwhile, if the charge amount is above or equal the predetermined amount, the energy management controller 150 operates to stop charging the storage medium 120.

Hence, the energy management controller 150 has a sequential mapping self-charge capability that recharges one of the reservoirs, for example the storage medium 120, when the voltage potential drops by a predetermined amount, for example 10% of its maximum voltage storage capacity. Hence, the supercapacitor charge system 100 creates a high efficient power retention and has a self-diagnostic feature.

For another example, the energy management controller 150 may detect a charge amount of the supercapacitor 110. If the charge amount is below a predetermined amount, the energy management controller 150 operates to charge the supercapacitor 110. Meanwhile, if the charge amount is above or equal the predetermined amount, the energy management controller 150 operates to stop charging the supercapacitor 110.

The discharge and charge of the storage medium 120 may occur periodically and therefore forms a charge-discharge cycle of the storage medium 120. The process of charge and discharge of the supercapacitor 110 may occur periodically and therefore forms a charge-discharge cycle of the supercapacitor 110.

The energy management controller 150 is operable to compute a Fourier transform line integration formulation for a voltage differential optimization to transform input variables to output. In some embodiments, the energy management controller 150 computes a Fast Fourier transform (‘FFT’) which optimize the complex integrated input composite signals from the vehicle electrical load factor and vehicle EMS (Engine Management System) by computing an n-by-n matrix. The matrix may be implemented as a Discrete Fourier transform (‘DFT’) matrix. DFT is the resultant interpolation of multiplying an input vector x of n numbers by the n-by-n matrix “Fn” to get an output vector y of n numbers governed by a formulation y=Fn·x. In some embodiments, n is a variable polynomial integer and may be predetermined by one or more firmware macro subroutines whenever the algorithm firmware modem 151 refreshes at pre-set interval (for example, every 11 ns), and x is a coefficient value. In some embodiments, the integrated input composite signals comprise at least one of the following signals: vehicle engine cranking load signals, super turbo electrical load signals, compressor load signals and fan and fuel pump load signals.

In some embodiments, a super turbo hardware driven technology is activated above a predetermined number of revolutions per minute (for example 2000 rpm) where one or more turbochargers are activated or initialized. The super turbo hardware driven technology is driven by increasing engine exhaust velocity and providing considerable kick in on power band. The turbochargers provide immediate instantaneous power and compensation for lag or delay associated with the turbochargers at low rpm. Therefore, the turbochargers require electrical power drain from the vehicle battery reservoir.

In some embodiments, the energy management controller 150 may compute the Fourier transform line integration formulation at a pre-set interval, for example every 11 ns, to optimize the charge and discharge of discrete quantum energy onto a vehicle engine load 180. For computing the Fourier transform line integration formulation, the energy management controller 150 includes one or more sensors for sensing and capturing input variables and database for storing at least one of the input variables and output variables. It is to be appreciated that the one or more sensors may include hard and/or soft sensors. Therefore, the sensing of the input variables or parameters are done by the energy management controller 150's sensing, specifically the algorithm firmware modem's 151 sensing. The energy management controller 150 transforms the rows and columns, calculates the number of signal points, does a bit reversal, computes the Fast Fourier transform, and scales for forward transform.

In some embodiments, the input variables may comprise composite signals of a vehicle electrical controller unit (‘ECU’) and voltage differential and current differential composite signals detected by the one or more sensors which may include volt-meters, amp-meters or electrical power meters working in tandem with soft sensors to obtain any resulting voltage differential and current differential signals. These input variables are then processed by the Fourier transform algorithm which synchronizes the frequency variance and phase shift. In some embodiments, the Fourier transform algorithm may be a Fast Fourier transform. In other embodiments, the Fourier transform algorithm uses Line Vector Integration for voltage and current optimization. The output variables may be manipulated through sequential integration for stabilization, balancing, noise suppression, back electromagnetic field (hereinafter referred to as EMF′) and electromagnetic interference (hereinafter referred to as ‘EMI’) filtration.

In this way, the energy management controller 150 may compute one or more normalization curves for comparison with the reference voltage signal for a voltage differential optimization at every 11 ns. Although not shown, the energy management controller 150 may utilize a master reference clock for the cross-reference.

The Fourier transform is an algorithm utilized for signal processing, image processing, and data compression. The Fourier transform can be described as multiplying an input vector x of n numbers by a particular n-by-n matrix Fₙ, called a discrete Fourier transform (hereinafter referred to as a ‘DFT’) matrix, to get an output vector y of n numbers: y=Fₙ·x. This is one of the simplest way to describe the Fourier transform and shows that a straightforward implementation with 2 nested loops would cost 2n² operations. The importance of the Fourier transform is that it performs this matrix-vector in just O (n log n) steps using divide-and-conquer. Furthermore, it is possible to compute x from y, i.e. compute x=F⁻¹ₙ y, using nearly the same algorithm. Practical uses of the Fourier transform require both multiplying by Fₙ and F⁻¹ₙ.

The Fourier transform can also be described as evaluating a polynomial with coefficients in x at a special set of n points, to get n polynomial values in y. This polynomial evaluation-interpretation is used to derive an O (n log n) algorithm. The inverse operation is referred to as interpolation: given the values of the polynomial y, find its coefficients x. To pursue the signal processing interpretation mentioned above, imagine measuring a spectrum of signal wavelength with a set of notes. Each note has a characteristic frequency (for example, middle A is 440 cycles per second). Digitizing this wavelength spectrum will produce a sequence of numbers that represent this set of notes, by measuring the spaced sampling times t₁, t₂, . . . , tᵢ, where tᵢ=i·Δt, Δt is the interval between consecutive samples, and 1/Δt is called as the sampling frequency. If there were only the single and pure middle A frequency, then the sequence of numbers representing these notes would form a sine curve, xᵢ=d·sin(2·π·tᵢ·440). As an example, suppose 1/Δt=45056 per second (or 45056 Hertz), which is a reasonable 1 sampling frequency for the signal note. The scalar d is the maximum amplitude of the curve, which depends on the signal strength and optimization.

In general, the energy management controller 150 is operable to utilize a numerical integration formulation in conjunction with or in alternative to the Fourier transform line integration formulation. In some embodiments, the energy management controller 150 is operable to utilize the numerical integration formulation and the Fourier transform line integration formulation.

The energy management controller 150 is operable to utilize the numerical integration formulation by evaluating an integrand to obtain an approximation to an integral. The energy management controller 150 evaluates the integrand at a finite set of points (referred to as integration points). A weighted sum of the evaluated integrand is used to approximate the integral. The integration points and weights may depend on the utilized method (for example, the numeric integration method) and the accuracy required from the approximation.

The numerical integration method relates an approximation error as a function of the number of evaluations of the integrand. As the number of evaluations of the integrand is reduced, the number of arithmetic operations may be reduced, and therefore total round-off errors may be reduced. In this regard, the numerical integration method may increase accuracy for optimization of the charge and discharge of discrete quantum energy onto a vehicle engine load 180.

In some embodiments, the integral over infinite intervals between region of a and b is calculated based on the following mathematical expression in equation (1):

$${\int }_{- ∞}^{+ ∞} f ( x ) dx = {\int }_{- 1}^{+ 1} f ( \frac{t}{1 - {t}^{2}} ) \frac{1 + {t}^{2}}{{( 1 - {t}^{2} )}^{2}} dt , \qquad ( 1 )$$

wherein a and b are integration points, f(x) is integrand, x is polynomials interpolation function, and t is infinite time interval.

In other embodiments, the integral is calculated for semi-infinite intervals based on the following mathematical expressions in equations (2) and (3):

$$\begin{matrix}{\int }_{a}^{+ ∞} f ( x ) dx = {\int }_{0}^{1} f ( a + \frac{t}{1 - t} ) \frac{dt}{{( 1 - t )}^{2}} & ( 2 ) \\ {\int }_{- ∞}^{a} f ( x ) dx = {\int }_{0}^{1} f ( a - \frac{1 - t}{t} ) \frac{dt}{{t}^{2}} & ( 3 )\end{matrix}$$

wherein a is integration point, f(x) is integrand, x is polynomials interpolation function, and t is infinite time interval.

The EMF and/or EMI are reduced by a feedback ferrite loop coil which is interfaced or arranged in data communication to be controlled by the firmware algorithm modem 151. In some embodiments, the firmware algorithm modem 151 may compute a statistical extrapolation to manipulate the EMI Induction. The EMI is also referred to as RFI (Radio Frequency Interference) under the radio frequency spectrum, and is a disturbance generated by an external source, for example a vehicle compressor, fan motor, alternator, fuel pump motor or water pump motor, that affects an electrical circuit by electromagnetic induction, electrostatic coupling or conduction.

In some embodiments, the firmware algorithm modem 151 utilizes a macro command to compute the EMI or RFI based on the following mathematical expression in equation (4) for EMI susceptibility:

$$Vi = \frac{2 AEFB}{300 S} \qquad ( 4 )$$

wherein Vᵢ is voltage induced into the loop, A is loop area in square meter, E is field strength in volts per meter, F is frequency in megahertz, B is bandwidth factor (in case of in band, B is 1; in case of out of band, B is circuit attenuation), and S is shielding (ratio) protecting circuit.

Meanwhile, the oscillation of the supercapacitor 110 causes an induced frequency. Further, a noise voltage comes from at least one of an external charger 170, for example an alternator, a generator, a magneto and an ignition system such as capacitor discharge ignition (hereinafter referred to as a ‘CDI’) of the vehicle. The transient noise and/or voltage spikes need to be reduced, dampened, or mitigated in order to reduce engine vibration(s) and provide a desirable output with good power quality.

The supercapacitor charge system 100 comprises a voltage balance circuitry relating to the charge balancing controller 140 and a stabilization and equalization circuitry relating to the stabilization and equalization controller 130. In some embodiments, the voltage balance circuitry and/or the stabilization and equalization circuitry may be integrated with the firmware algorithm modem 151 of the energy management controller 150. The energy management controller 150 therefore may use an algorithm to manage the energy distribution by interfacing with the stabilization and equalization controller 130 and the charge balancing controller 140. The energy management controller 150 may be synchronized with the stabilization and equalization controller 130 and the charge balancing controller 140 for the transient noise suppression, voltage spikes suppression, frequency stabilization and/or balancing of the overall energy distribution. In this way, the stabilization and equalization controller 130 is operable to dampen the noise voltage for the voltage stabilization of the overall energy distribution.

Also, the charge balancing controller 140 is operable to supress an overcharge of the supercapacitor 110. Hence, the supercapacitor charge system 100 is allowed to improve a performance such as power to torque ratio, improve a quality of a lighting system of the vehicle, improve a quality of a sound system of the vehicle, extend life of the supercapacitor 110 and the storage medium 120, and/or enable fuel savings. The supercapacitor charge system 100 further includes a kinetic energy recovery system (hereinafter referred to as a ‘KERS’) 160 and an external charger 170.

The KERS 160 is an automotive system for recovering a moving vehicle's kinetic energy under braking. The recovered energy is stored in a reservoir, for example a flywheel or high voltage batteries, for later use under acceleration. In some embodiments, the KERS 160 is connected with the supercapacitor charge system 100 as an external media. The energy management controller 150 manages the energy distribution by interfacing with the KERS 160.

In some embodiments, the KERS 160 is operable to capture kinetic energy under braking of the vehicle. The KERS 160 converts the captured kinetic energy to electrical energy by a traction motor and transfers the converted energy in at least one of the supercapacitor 110 and the storage medium 120 so that the kinetic energy generated under braking can be reused in the supercapacitor 110 and the storage medium 120 (i.e. regenerative braking). Also, the KERS 160 is operable to power up the supercapacitor charge system 100 so that the supercapacitor charge system 100 can supply power to the vehicle. As a result, in an embodiment, the vehicle is able to start.

In other embodiments, electronic devices of the vehicle, for example navigation device and black box, are able to operate.

For example, the access time (for example, transient rise and fall time in 3 to 4 ns) of the firmware algorithm modem's 151 computation is a guard band to capture the KERS 160 electrical energy generated by the traction motor in less than 5 ns. Therefore, most of (for example, 90 to 95%) KERS's 160 kinetic energy is channelled to the supercapacitor charge system 100 to charge up the supercapacitor charge system 100.

The external charger 170 is also connected with the supercapacitor charge system 100 as an external media. The energy management controller 150 manages the energy distribution by interfacing with the external charger 170.

The external charger 170 includes an induction coil motor which an electromagnetic induced potential energy is created when a rotor core is spinning inside stator core windings. The external charger 170 is operable to power up the supercapacitor charge system 100 so that the supercapacitor charge system 100 can supply power to the vehicle. The external charger 170 includes at least one of an alternator, a generator and a charger. The type of the external charger 170 can vary depending on the type of vehicle.

In some embodiments, the external charger 170 is arranged to interface with the vehicle roof top solar panel. The firmware algorithm modem 151 in the energy management controller 150 comprises logic implemented to operate as a solar auto charger unit for optimizing the charging rate of the lithium iron phosphate medium and the supercapacitor charge system 100, and to prevent the lithium iron phosphate medium and the supercapacitor charge system 100 from overcharging as there is a max current limitation level set in the firmware algorithm modem's 151 upper current control limits.

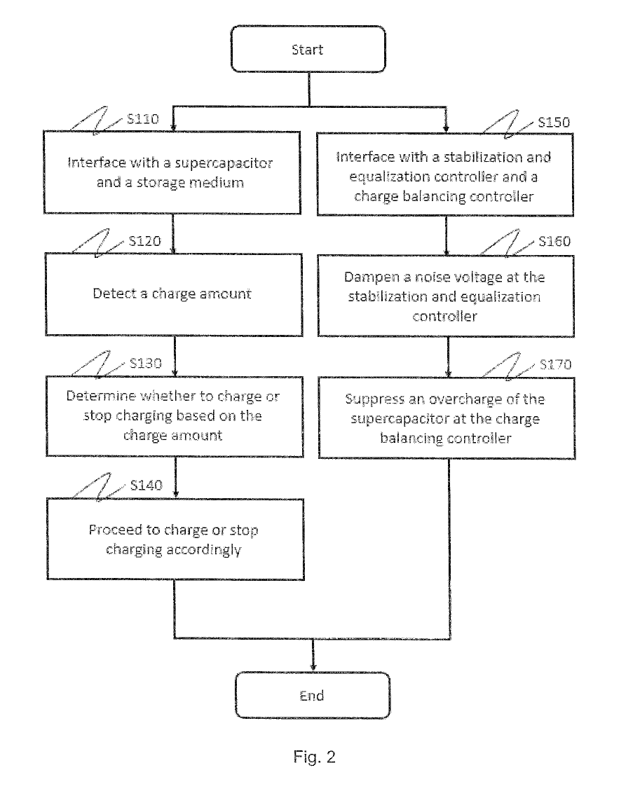

FIG. 2 illustrates a flow diagram of a supercapacitor charge method in accordance with an embodiment of the invention.

Firstly, the energy management controller 150 interfaces with the supercapacitor 110 and the storage medium 120 (S110). The energy management controller 150 is operable to control charge and discharge of the supercapacitor 110 and the storage medium 120 for an energy distribution. Although not shown, the energy management controller 150 may control the supercapacitor 110 and the storage medium 120 separately. Meanwhile, the energy management controller 150 may control the supercapacitor 110 and the storage medium 120 at the same time.

The energy management controller 150 includes an algorithm firmware modem 151 which is a programmable chip and is operable to support electronic components of the supercapacitor charge system 100. A user is able to enter a command into the algorithm firmware modem 151 via a user interface (not shown).

For example, the user is able to enter the command so that the energy management controller 150 can start to charge the storage medium 120 when the charge amount is below a predetermined amount. Then, the energy management controller 150 is able to operate according to the command.

For another example, the user is able to enter the command so that the energy management controller 150 can start to charge the supercapacitor 110 when the charge amount is below a predetermined amount. Then, the energy management controller 150 is able to operate according to the command. Meanwhile, although not shown, the ‘predetermined amount’ may be present without the user's command.

The energy management controller 150 detects the charge amount (S120). The energy management controller 150 may monitor the power, for example the charge amount. The charge amount includes at least one of a charge amount of the storage medium 120 and a charge amount of the supercapacitor 110.

After that, the energy management controller 150 determines whether to charge or stop charging based on the charge amount (S130).

For example, if the charge amount is below the predetermined amount, the energy management controller 150 operates to charge storage medium 120. Then, the storage medium 120 is charged (S140). For another example, if the charge amount is below the predetermined amount, the energy management controller 150 operates to charge the supercapacitor 110. Then, the supercapacitor 110 is charged (S140).

On the other hand, if the charge amount is above or equal the predetermined amount, the energy management controller 150 operates to stop charging. Although not shown, the energy management controller 150 continues to monitor the power.

Although not shown, as one of the supercapacitor 110 and the storage medium 120 is charged, another one of the supercapacitor 110 and the storage medium 120 may be discharged.

Hence, the energy management controller 150 has a sequential mapping self-charge capability, creates a high efficient power retention and has a self-diagnostic feature.

Meanwhile, the energy management controller 150 interfaces with the stabilization and equalization controller 130 and the charge balancing controller 140 (S150). The energy management controller 150 may be synchronized with the stabilization and equalization controller 130 and the charge balancing controller 140 for managing the energy distribution.

The stabilization and equalization controller 130 dampens a noise voltage (S160) for the voltage stabilization of the overall energy distribution. Further, the charge balancing controller 140 suppresses an overcharge of the supercapacitor 110 (S170). Thus, the supercapacitor charge system 100 is allowed to improve a performance such as not only power to torque ratio but also output horse power, improve a quality of the vehicle system, and enable fuel savings.

The energy management controller 150 may operate a first group of the steps (S110 to S140) with a second group of the steps (S150 to S170) concurrently. On the other hand, the energy management controller 150 may operate the first group of the steps and the second group of the steps in sequential order. For example, the energy management controller 150 may operate the first group of the steps, and then operate the second group of the steps.

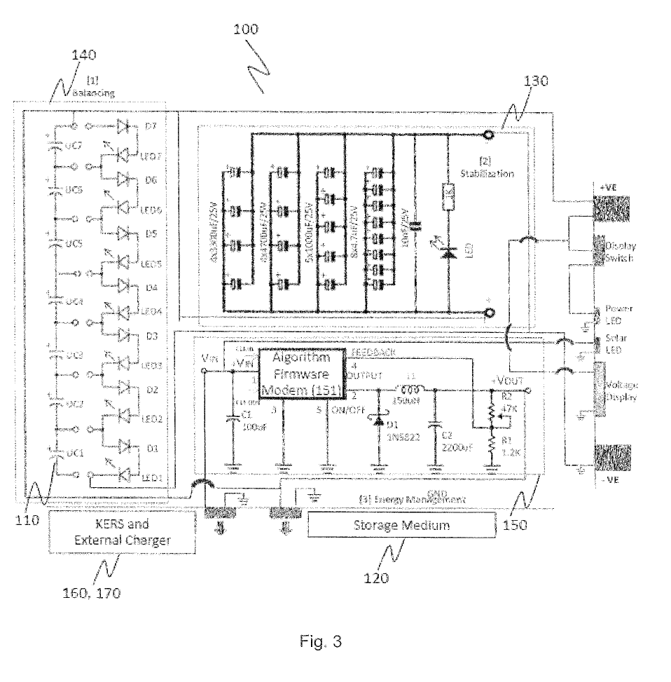

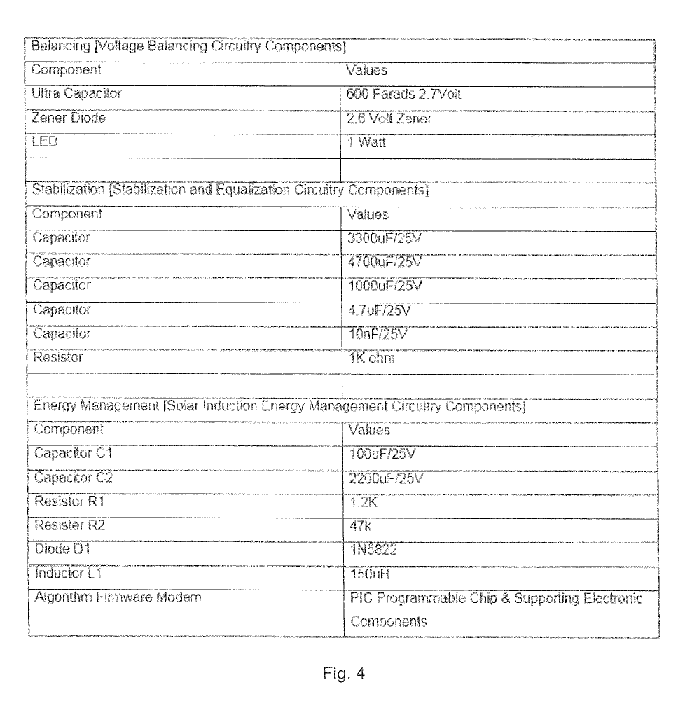

FIG. 3 illustrates a schematic diagram of a supercapacitor charge system 100 in accordance with an embodiment of the invention. Specifically, FIG. 3 depicts the schematic diagram of the supercapacitor charge system 100 which comprises a voltage balance circuitry relating to the charge balancing controller 140, a stabilization and equalization circuitry relating to the stabilization and equalization controller 130 and an energy management firmware circuitry relating to the energy management controller 150. FIG. 4 illustrates a table showing values of circuitry component illustrated in FIG. 3 in accordance with an embodiment of the invention.

The supercapacitors 110 (UC1 to UC7) are in the voltage balancing circuitry. The voltage balancing circuitry comprises, in series between each cell, a light emitting diode (hereinafter referred to as an ‘LED’) and a Zener diode. Specifically, the LED and the Zener diode are wired in series between each supercapacitor 110.

For example, the maximum volt value of the supercapacitor 110 may be 2.7V, but is not limited to this value. These electrical components cause any voltage above 2.7V to dump through the Zener diode and the LED causing the LED to light up and causing the supercapacitor 110 to be drained until it reaches 2.7V. While charging, once all the LEDs light up, it is an indication that all the supercapacitors 110 are fully charged up and balanced.

The stabilization and equalization circuitry comprises a plurality of capacitors and a resistor. The stabilization and equalization circuitry works as a damper for the noise voltage suppression. For example, the algorithm will capture the transient noise interference signals from the engine load (like the compressor noise, fan motor noise or alternator noise), and generate a similar amplitude composite counteract opposing signal for noise cancellation. In some embodiments, the stabilization and equalization circuitry comprises low-pass, high-pass or band-pass filters to filter the high and low frequency noise signals and voltage spikes.

Each customized capacitor is selected to reduce the amount of noise voltage that is different. The smaller the value of its capacitance, the higher the frequency to be suppressed from the electrical system. The algorithm firmware modem 151 of the energy management firmware 150 utilizes a macro subroutine command to vary the capacitances and voltage of the circuitry for the electrical stabilization and balancing of the vehicle.

Generally defects and/or the noise voltage come from at least one of the external charger 170, for example an alternator, the generator, the magneto and the ignition system such as the CDI of the vehicle. The noise voltage needs to be improved or mitigated in order to reduce engine vibration(s) and provide a desirable output with good power quality.

The energy management firmware circuitry comprises a plurality of capacitors, a plurality of registers, a diode, an inductor and the algorithm firmware modem 151. The algorithm firmware modem 151 is a programmable chip, and acts as a programmable charge and discharge quantum energy controller, a flyback and a forward converter comparator. Specifically, the flyback and the forward converter comparator are featured in the feedback loop of the mapping signal integration where the firmware computes the normalization curves for comparison with the reference voltage signal for a voltage differential optimization at every 11 ns.

The algorithm firmware modem 151 has a wide input voltage range, for example 9V to 20V, with a programmable operating speed of 20 MHz oscillator clock input and 200 ns instruction cycle. It is understood that the input voltage range can vary depending on the type of vehicle. The programmable modem includes programmable code protection and pulse width modulation (‘PWM’) high endurance protection mode to provide associated protection circuitry consisting current/thermal limiting and under voltage lockout.

The algorithm firmware modem 151 has software selectable frequency range of 32 kHz to 8 MHz. Also, the algorithm firmware modem 151 has an internal on-chip oscillator that requires no external components, soft start mode to reduce in-rush current during start-up and current mode control for improved rejection of input voltage and output load transients.

By in circuit programming the modem chip, the algorithm firmware modem 151 can trigger different charge or discharge output quantum level in real dynamic mode for efficient energy management of the KERS 160 and the external charger 170 charging of the supercapacitor 110 and the storage medium 120.

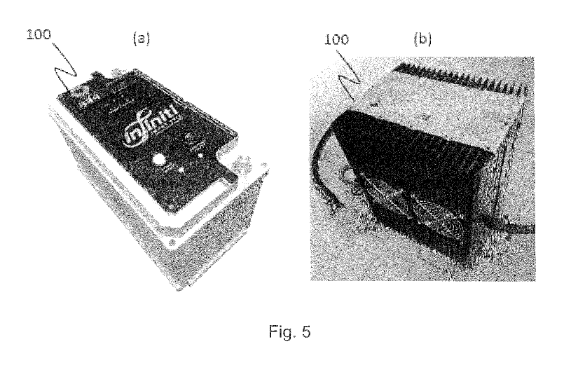

FIG. 5 illustrates an example of a supercapacitor charge system 100 in accordance with an embodiment of the invention.

As shown in FIGS. 5 (a) and (b), each component is assembled as the supercapacitor charge system 100. The supercapacitor charge system 100 comprises the supercapacitor 110 as an immediate main energy peripheral reservoir, the stabilization and equalization controller 130, the charge balancing controller 140 and the energy management controller 150. The supercapacitor charge system 100 may further comprise the KERS 160 and the external charger 170, for example an alternator. The supercapacitor charge system 100 may further include a storage medium 120. One example of the storage medium 120 is a lithium iron phosphate (LiFePO₄) medium.

The functions of the storage medium 120 and an external charger 170 can vary depending on the type of vehicle, for example car and forklift, as shown in FIGS. 5 (a) and (b).

FIG. 5 (a) shows a supercapacitor charge system 100 for installation in a car. In this embodiment, the main source of an electrical input comes from the external charger 170, for example alternator. The storage medium 120, for example lithium iron phosphate medium, provides a first initial charge to the supercapacitor 110. In this embodiment, the supercapacitor charge system 100 may be disconnected from the storage medium 120 since the electrical energy (for example, petrol or diesel) is provided to the supercapacitor charge system 100.

FIG. 5 (b) shows a supercapacitor charge system 100 for installation in a forklift. In this embodiment, the external charger 170, for example charger, charges the storage medium 120, for example lithium iron phosphate medium, and the storage medium 120 provides electrical power to the supercapacitor 110. In other words, the storage medium 120 may be a main source to provide the electrical power to the supercapacitor 110 to run the forklift. In this embodiment, the supercapacitor charge system 100 may depend on the storage medium 120 in order to obtain the electrical energy.

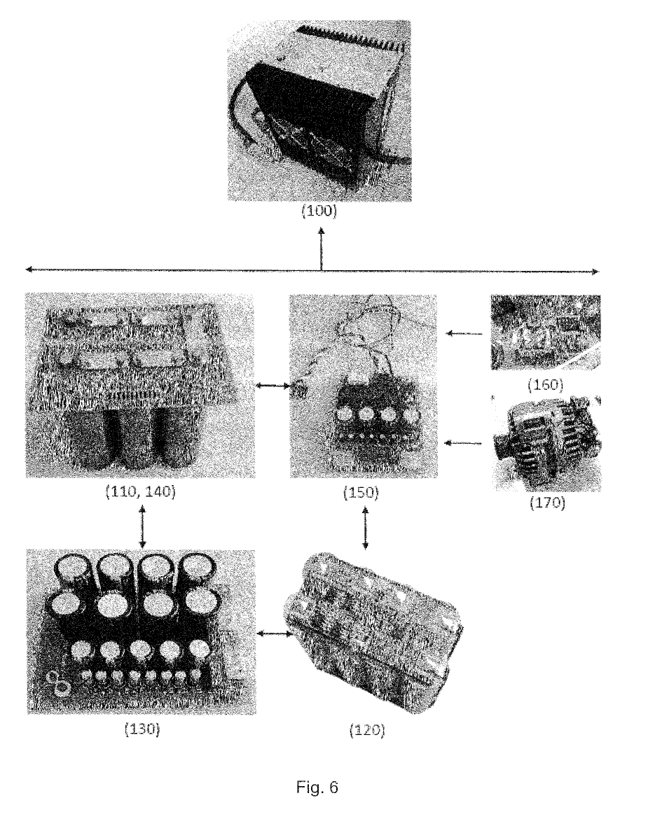

FIG. 6 illustrates a modular layout of a supercapacitor charge system 100 in accordance with an embodiment of the invention.

The supercapacitor charge system 100 comprises the supercapacitor 110 as an immediate main energy peripheral reservoir, the storage medium 120 as a buffer energy reservoir, the stabilization and equalization controller 130, the charge balancing controller 140 and the energy management controller 150. As shown in FIG. 6, the supercapacitor 110 may be integrated with the charge balancing controller 140.

The supercapacitor charge system 100 may further comprise the KERS 160 and the external charger 170, for example alternator, as external media.

The KERS 160 basically includes an electrical traction motor that converts the mechanical kinetic energy during braking into the electrical energy and transfers the regenerative energy into the storage medium like the vehicle battery reservoir. The KERS 160 has been used in the motor sports formula in 2013. One of the reasons that not all vehicles use the KERS 160 is that the KERS 160 raises the vehicle's centre of gravity and reduces the amount of ballast that is available to balance the vehicle so that it is more predictable when turning.

As described above, the KERS 160 converts the kinetic energy to an electrical energy by a traction motor and transfers the converted energy in at least one of the supercapacitor 110 and the storage medium 120 so that the discrete kinetic energy can be reused in the supercapacitor 110 and the storage medium 120. Also, the KERS 160 is operable to power up the supercapacitor charge system 100 so that the supercapacitor charge system 100 can supply power to the vehicle.

The external charger 170 includes an induction coil motor which an electromagnetic induced potential energy is created when a rotor core is spinning inside stator core windings. The external charger 170 is operable to power up the supercapacitor charge system 100 so that the supercapacitor charge system 100 can supply power to the vehicle.

The energy management controller 150 manages the energy distribution by interfacing with the KERS 160 and the external charger 170. Specifically, the algorithm firmware spectrum bandwidth (upper and lower guard band bandwidth) of the algorithm firmware modem 151 is customized to capture the electrical energy generated by the traction motor of the KERS 160.

As described above, the energy management controller 150 further manages the energy distribution by interfacing with the stabilization and equalization controller 130 and the charge balancing controller 140. The energy management controller 150 basically controls charge and discharge of the supercapacitor 110 and the storage medium 120.

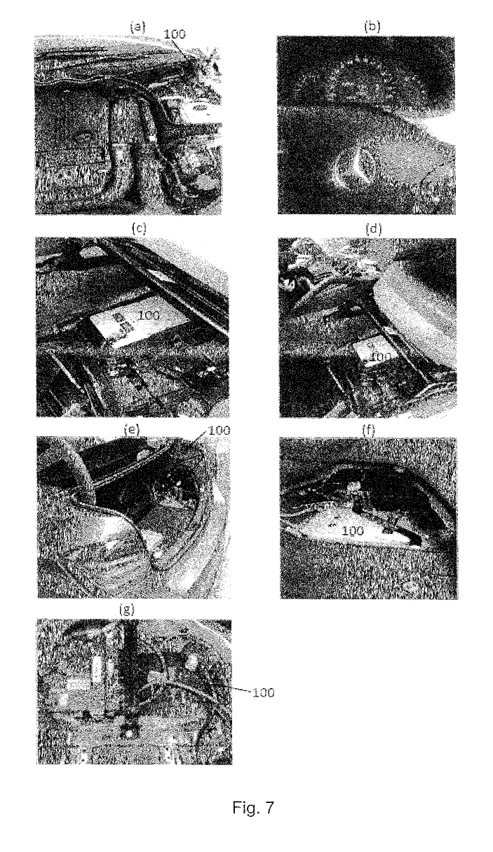

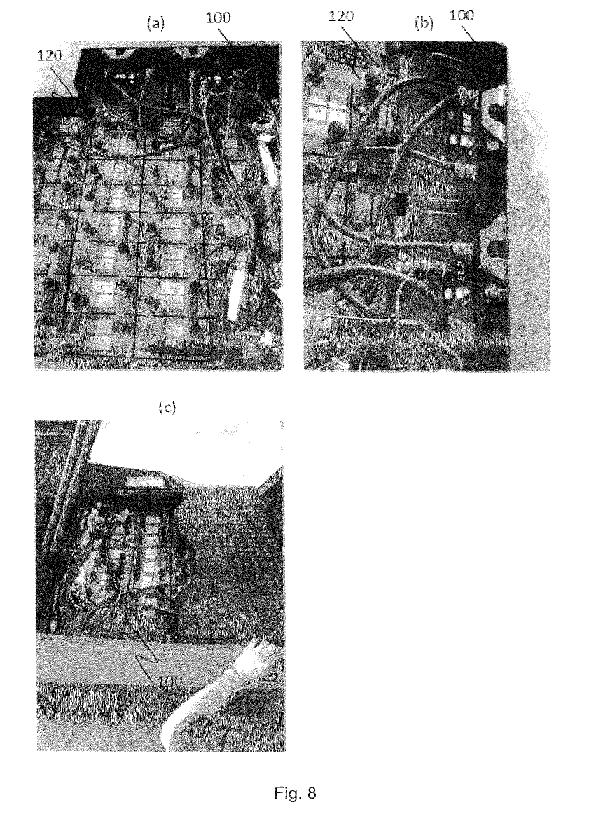

FIGS. 7 and 8 illustrate examples of a practical application of a supercapacitor charge system 100 in accordance with an embodiment of the invention.

FIG. 7 shows examples of a practical application of a supercapacitor charge system 100 installed in a car, the car comprising a 2.4 L engine.

As shown in FIGS. 7 (a) and (b), the supercapacitor charge system 100 can ignite the 2.4 L engine vehicle instantaneously. As shown in FIGS. 7 (c) and (d), the supercapacitor charge system 100 can be installed in the 4× wheel drive vehicle for igniting. As shown in FIGS. 7 (e) and (f), the supercapacitor charge system 100 can also be installed in the battery compartment of a 328i vehicle replacing the toxic battery, for example lead acid battery. As shown in FIG. 7 (g), the supercapacitor charge system 100 can also be installed in the battery compartment of a 523i vehicle to replace the conventional lead acid battery.

FIG. 8 shows examples of a practical application of a supercapacitor charge system 100 installed in a forklift.

As shown in FIGS. 8 (a), (b) and (c), the external charger 170, for example charger, charges the storage medium 120, for example lithium iron phosphate medium, and the storage medium 120 may be a main source to provide electrical power to the supercapacitor 110. Thereafter, the supercapacitor charge system 100 can supply electrical power to the forklift DC electric motor to run the forklift. Although not shown, the supercapacitor charge system 100 can also supply electrical power to the electric fishing boat starter DC motor and can be powered up by a solar energy panel replacing diesel utilization.

As shown in FIGS. 7 and 8, the vehicle is not limited to an automobile such as a gas engine vehicle and a hybrid or electric vehicle. The vehicle includes a marine electric boat, a heavy industrial vehicle such as a forklift and a truck, and other portable power storage medium. In summary, the vehicle includes a ground vehicle, an underwater vehicle, and an aerial vehicle.

When the supercapacitor charge system 100 is fitted into the battery compartment of the vehicle combustion engine, replacing the non-environmental friendly battery, for example lead acid battery, completely, the vehicle engine can easily be ignited and the vehicle can received an instantaneous boost of energy delivered by the supercapacitor 110 and the user (driver) will feel the immediate sensation of the high acceleration response and performance efficiency of the vehicle.

Also there is an increase in the engine output torque and the sensitivity of shift gearing. The supercapacitor charge system 100 also improves the vehicle ignition efficiency and lessens fuel consumption (for example, over 10% during highway driving). The stabilization and equalization controller 130 installed in the supercapacitor charge system 100 enhances the current output and reduces the engine vibration due to a sparkplug complete combustion. The supercapacitor charge system 100 increases the sensitivity and accuracy of signals of the vehicle electrical controller unit (‘ECU’) that is the vehicle computerised hardware controller hidden inside the dashboard of the vehicle. The supercapacitor charge system 100 increases the sensitivity and accuracy of sensors, and optimizes the fuel consumption, the output power and the vehicle handling safety.

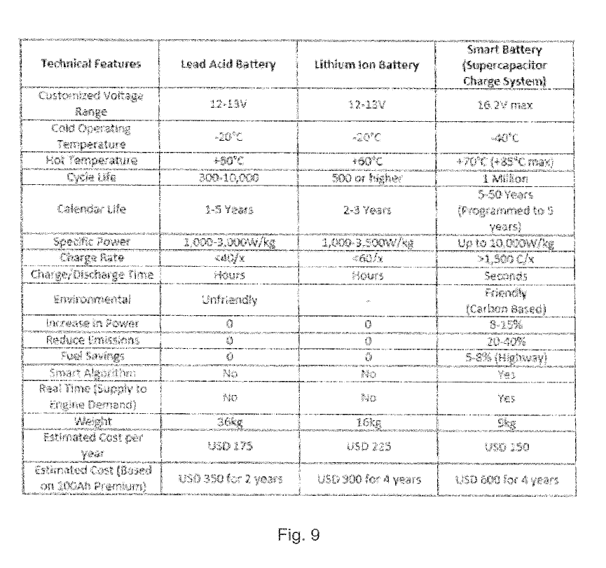

FIG. 9 illustrates a table showing advantages of a supercapacitor charge system 100 in accordance with an embodiment of the invention compared with conventional batteries.

The supercapacitor charge system 100 has advantages over the lead acid battery and the lithium ion battery used in the vehicle.

As shown in FIG. 9, the supercapacitor charge system 100 can withstand extreme operating temperature, for example −40° C. to 70° C., suitable for any vehicle in any weather condition. Further, the supercapacitor charge system 100 has a high life cycle from 5 to 50 years. The supercapacitor charge system 100 has fast charge and discharge rate, for example 30 seconds to be fully charged by the external charger 170 of the vehicle.

Also, the supercapacitor charge system 100 is environmental friendly. The supercapacitor charge system 100 does not contain any acidic chemicals, all dry and sealed components. For example, a diesel vehicle installed with the supercapacitor charge system 100 is able to reduce emissions such as CO (carbon monoxide), HC (hydrocarbons) and NOₓ (nitrogen oxide) compared to a diesel vehicle installed with a conventional lead acid battery. In another example, a petrol vehicle installed with the supercapacitor charge system 100 is able to reduce the emissions such as CO, HC, NOₓ and PN (particle number) compared to a petrol vehicle installed with the conventional lead acid battery. It is to be appreciated that the emissions reduction ratio in the petrol vehicle may be higher than the diesel vehicle.

Also, the supercapacitor charge system 100 has relatively lightweight compared to other conventional car battery systems. In addition, the algorithm firmware modem 151 of the energy management controller 150 is operable to have rapid responses to the vehicle's kinetic energy brake recovery system besides the external charger 170.

Moreover, the supercapacitor charge system 100 can induce the differential voltage gradient to the supercapacitor 110. The algorithm firmware modem 151 is custom-designed to have a sequential mapping self-charge capability that recharges the storage medium 120 when the voltage potential drops by a predetermined amount, for example 10% of its maximum voltage storage capacity. Hence, the supercapacitor charge system 100 creates a high efficient power retention and has a self-diagnostic feature.

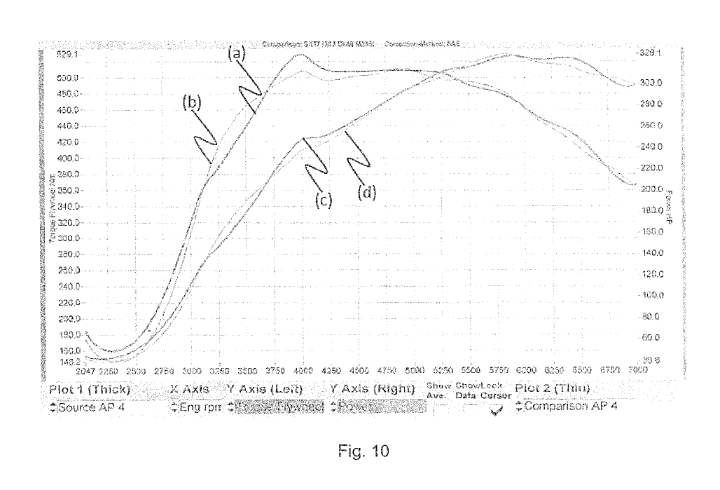

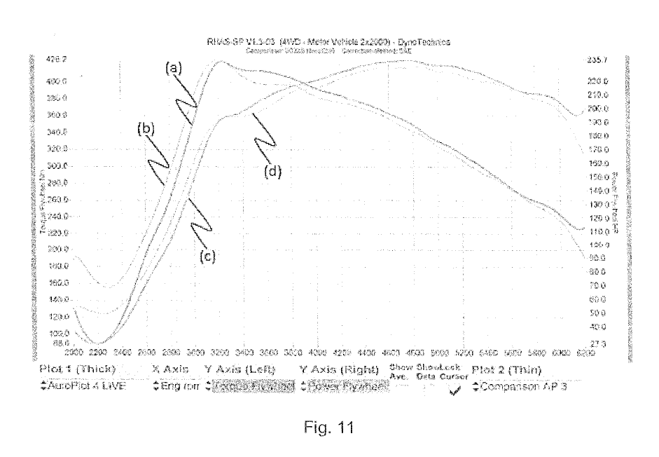

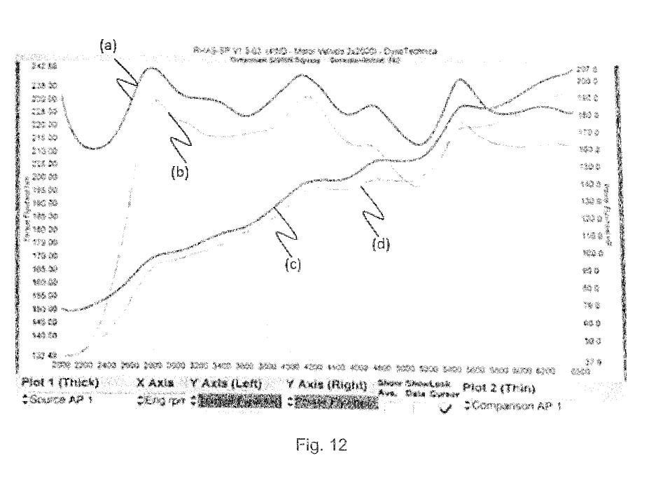

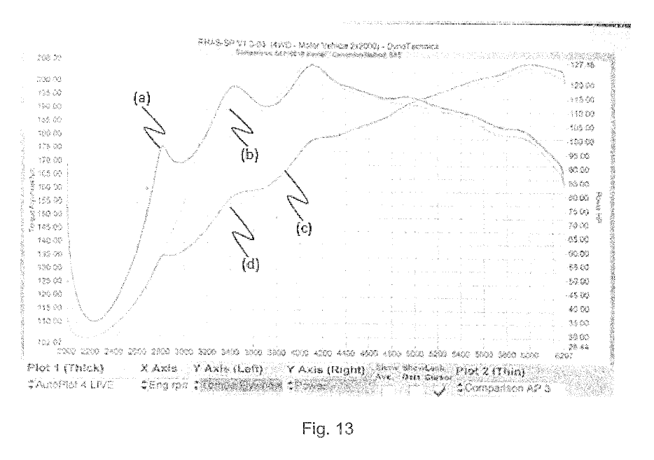

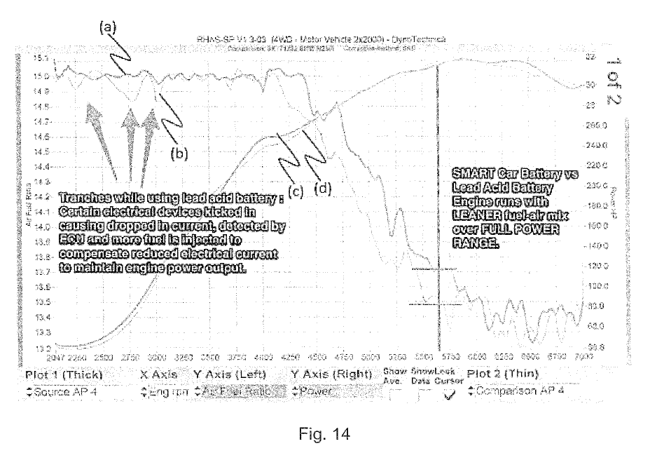

FIGS. 10 to 13 illustrate line graphs showing torque and power output from the supercapacitor charge system 100 and method compared with a conventional battery in various vehicles. FIG. 14 illustrates line graphs showing air fuel ratio and power output from the supercapacitor charge system 100 and method compared with the conventional battery. The x-axis of the line graphs is engine revolutions per minute (hereinafter referred to as ‘RPM’).

As an example, in FIGS. 10 to 13, the supercapacitor charge system 100 and the conventional battery, for example lead acid battery, are installed in each of a coupe, a sedan, a minivan and a SUV. FIGS. 10 (a), 11 (a), 12 (a) and 13 (a) show torque on a flywheel along with the engine RPM in the supercapacitor charge system 100, while FIGS. 10 (b), 11 (b), 12 (b) and 13 (b) show torque on a flywheel along with the engine RPM in the lead acid battery. FIGS. 10 (c), 11(c), 12 (c) and 13 (c) show power output, for example horsepower output, along with the engine RPM in the supercapacitor charge system 100, while FIGS. 10 (d), 11 (d), 12 (d) and 13(d) show horsepower output along with the engine RPM in the lead acid battery.

As an example, in FIG. 14, the supercapacitor charge system 100 and the lead acid battery are installed in the coupe. FIGS. 14 (a) and (b) show air fuel ratio along with the engine RPM in each of the supercapacitor charge system 100 and the lead acid battery. FIGS. 14 (c) and (d) show horsepower output along with the engine RPM in each of the supercapacitor charge system 100 and the lead acid battery.

According to the line graphs, overall, vehicles having the supercapacitor charge system 100 have higher torque, horsepower output and air fuel ratio compared to vehicles having the lead acid battery. The reasons are at least as follows:
Optimization of voltage and current, and supply of them to current demand within nanoseconds
The energy management controller 150 of the supercapacitor charge system 100 computes the Fourier transform line integration formulation at a pre-set interval, for example every 11 ns, to optimize voltage and current.
The energy management controller 150 of the supercapacitor charge system 100 computes the numerical integration formulation to optimize voltage and current.
Reduced noise
The noise voltage comes from the external charger 170, for example an alternator, the generator, the magneto and the ignition system, of the vehicle. The stabilization and equalization controller 130 of the supercapacitor charge system 100 dampens the noise voltage.
Complete combustion
The supercapacitor charge system 100 discharges high current momentarily compared to the conventional battery, for example lead acid battery. Thus, the supercapacitor charge system 100 allows better and more complete combustion of fuel in the chamber.

It should be appreciated by the person skilled in the art that variations and combinations of features described above, not being alternatives or substitutes, may be combined to form yet further embodiments falling within the intended scope of the invention.

1. A supercapacitor charge system for a vehicle comprising:
at least one supercapacitor;
a stabilization and equalization controller operable to dampen a noise voltage;
a charge balancing controller operable to supress an overcharge of the at least one supercapacitor; and
an energy management controller operable to control charge and discharge of the at least one supercapacitor for an energy distribution and operable to manage the energy distribution by interfacing with the stabilization and equalization controller and the charge balancing controller,
wherein the energy management controller is operable to detect a charge amount and determine whether to charge or stop charging based on the charge amount.

2. The supercapacitor charge system according to claim 1, wherein the at least one supercapacitor is diffused with graphene onto an active carbon film.

3. The supercapacitor charge system according to claim 2, wherein diffusing of the graphene into an activated carbon anode is to lower a resistance of an electrical series resistors (ESR).

4. The supercapacitor charge system according to claim 1, wherein the at least one supercapacitor is integrated with the charge balancing controller.

5. The supercapacitor charge system according to claim 1 further comprising a storage medium operable to store buffer energy.

6. The supercapacitor charge system according to claim 5, wherein the storage medium includes a lithium iron phosphate medium.

7. The supercapacitor charge system according to claim 1, wherein the stabilization and equalization controller is operable to dampen the noise voltage which comes from at least one of the following: an alternator, a generator, a magneto and an ignition system.

8. The supercapacitor charge system according to claim 1, wherein the stabilization and equalization controller comprises a plurality of capacitors and a resistor.

9. The supercapacitor charge system according to claim 1, wherein the charge balancing controller comprises, in series between each cell, a light emitting diode (LED) and a Zener diode.

10. The supercapacitor charge system according to claim 9, wherein the LED lights up when the corresponding supercapacitor is fully charged up.

11. The supercapacitor charge system according to claim 5 further comprising a kinetic energy recovery system (KERS) connected as an external media and operable to capture a kinetic energy under braking.

12. The supercapacitor charge system according to claim 11, wherein the energy management controller is operable to manage the energy distribution by interfacing with the KERS.

13. The supercapacitor charge system according to claim 11, wherein the KERS is operable to convert the kinetic energy to an electrical energy and transfer the converted energy in at least one of the supercapacitor and the storage medium.

14. The supercapacitor charge system according to claim 13, wherein the KERS is operable to power up the supercapacitor charge system so that the supercapacitor charge system can supply power to the vehicle.

15. The supercapacitor charge system according to claim 5 further comprising an external charger connected as an external media and including an induction coil motor.

16. The supercapacitor charge system according to claim 15, wherein the external charger includes at least one of the following: an alternator, a generator and a charger.

17. The supercapacitor charge system according to claim 16, wherein the alternator is operable to power up the supercapacitor charge system so that the supercapacitor charge system can supply power to the vehicle.

18. The supercapacitor charge system according to claim 5, wherein the energy management controller is operable to control charge and discharge of the storage medium for the energy distribution.

19. The supercapacitor charge system according to claim 18, wherein the energy management controller is operable to discharge the storage medium in order to charge the at least one supercapacitor.

20. The supercapacitor charge system according to claim 19, wherein the energy management controller is operable to determine to charge one of the supercapacitor and the storage medium if the charge amount is below a predetermined amount.

21. The supercapacitor charge system according to claim 1, wherein the energy management controller is operable to be synchronized with the stabilization and equalization controller.

22. The supercapacitor charge system according to claim 5, wherein the energy management controller is operable to compute a Fourier transform line integration formulation at a pre-set interval to optimize the charge and discharge of the at least one supercapacitor and the storage medium.

23. The supercapacitor charge system according to claim 22, wherein the energy management controller is operable to compute the Fourier transform line integration formulation at every 11 ns.

24. The supercapacitor charge system according to claim 5, wherein the energy management controller is operable to compute a numerical integration formulation to optimize the charge and discharge of the at least one supercapacitor and the storage medium.

25. The supercapacitor charge system according to claim 1, wherein the energy management controller comprises a plurality of capacitors, a plurality of registers, a diode, an inductor and an algorithm firmware modem.

26. The supercapacitor charge system according to claim 25, wherein the algorithm firmware modem is a programmable chip and is operable to support electronic components.

27. The supercapacitor charge system according to claim 26, wherein the algorithm firmware modem is operable to trigger different charge and discharge output quantum level in a real dynamic mode in order to manage the energy distribution.

28. The supercapacitor charge system according to claim 16, wherein if the vehicle is a car, the storage medium provides a first initial charge to the supercapacitor, and the alternator provides power to the supercapacitor to run the car.

29. The supercapacitor charge system according to claim 16, wherein if the vehicle is a forklift, the charger charges the storage medium, and the storage medium provides power to the supercapacitor to run the forklift.

30. A supercapacitor charge method of a supercapacitor charge system for a vehicle comprising:
dampening a noise voltage at a stabilization and equalization controller;
supressing, at a charge balancing controller, an overcharge of at least one supercapacitor;
controlling, at an energy management controller, charge and discharge of the at least one supercapacitor for an energy distribution; and
managing, at the energy management controller, the energy distribution by interfacing with the stabilization and equalization controller and the charge balancing controller,
wherein the energy management controller is operable to detect a charge amount and determine whether to charge or stop charging based on the charge amount.

31. The supercapacitor charge method according to claim 30, wherein the at least one supercapacitor is diffused with graphene onto an active carbon film.

32. The supercapacitor charge method according to claim 31, wherein diffusing of the graphene into an activated carbon anode is to lower a resistance of an electrical series resistors (ESR).

33. The supercapacitor charge method according to claim 30, wherein the at least one supercapacitor is integrated with the charge balancing controller.

34. The supercapacitor charge method according to claim 30, wherein the supercapacitor charge system further comprises a storage medium operable to store buffer energy.

35. The supercapacitor charge method according to claim 34, wherein the storage medium includes a lithium iron phosphate medium.

36. The supercapacitor charge method according to claim 30, wherein the stabilization and equalization controller is operable to dampen the noise voltage which comes from at least one of the following: an alternator, a generator, a magneto and an ignition system.

37. The supercapacitor charge method according to claim 30, wherein the stabilization and equalization controller comprises a plurality of capacitors and a resistor.

38. The supercapacitor charge method according to claim 30, wherein the charge balancing controller comprises, in series between each cell, a light emitting diode (LED) and a Zener diode.

39. The supercapacitor charge method according to claim 38, wherein the LED lights up when the corresponding supercapacitor is fully charged up.

40. The supercapacitor charge method according to claim 34, wherein the supercapacitor charge system further comprises a kinetic energy recovery system (KERS) connected as an external media and operable to capture a kinetic energy under braking.

41. The supercapacitor charge method according to claim 40, wherein the energy management controller is operable to manage the energy distribution by interfacing with the KERS.

42. The supercapacitor charge method according to claim 40, wherein the KERS is operable to convert the kinetic energy to an electrical energy and transfer the converted energy in at least one of the supercapacitor and the storage medium.

43. The supercapacitor charge method according to claim 42, wherein the KERS is operable to power up the supercapacitor charge system so that the supercapacitor charge system can supply power to the vehicle.

44. The supercapacitor charge method according to claim 34, wherein the supercapacitor charge system further comprises an external charger connected as an external media and including an induction coil motor.

45. The supercapacitor charge method according to claim 44, wherein the external charger includes at least one of the following: an alternator, a generator and a charger.

46. The supercapacitor charge method according to claim 45, wherein the alternator is operable to power up the supercapacitor charge system so that the supercapacitor charge system can supply power to the vehicle.

47. The supercapacitor charge method according to claim 34, wherein the energy management controller is operable to control charge and discharge of the storage medium for the energy distribution.

48. The supercapacitor charge method according to claim 47, wherein the energy management controller is operable to discharge the storage medium in order to charge the at least one supercapacitor.

49. The supercapacitor charge method according to claim 48, wherein the energy management controller is operable to determine to charge one of the supercapacitor and the storage medium if the charge amount is below a predetermined amount.

50. The supercapacitor charge method according to claim 30, wherein the energy management controller is operable to be synchronized with the stabilization and equalization controller.

51. The supercapacitor charge method according to claim 34, wherein the energy management controller is operable to compute a Fourier transform line integration formulation at a pre-set interval to optimize the charge and discharge of the at least one supercapacitor and the storage medium.

52. The supercapacitor charge method according to claim 51, wherein the energy management controller is operable to compute the Fourier transform line integration formulation at every 11 ns.

53. The supercapacitor charge method according to claim 34, wherein the energy management controller is operable to compute a numerical integration formulation to optimize the charge and discharge of the at least one supercapacitor and the storage medium.

54. The supercapacitor charge method according to claim 30, wherein the energy management controller comprises a plurality of capacitors, a plurality of registers, a diode, an inductor and an algorithm firmware modem.

55. The supercapacitor charge method according to claim 54, wherein the algorithm firmware modem is a programmable chip and is operable to support electronic components.

56. The supercapacitor charge method according to claim 55, wherein the algorithm firmware modem is operable to trigger different charge and discharge output quantum level in a real dynamic mode in order to manage the energy distribution.

57. The supercapacitor charge method according to claim 45, wherein if the vehicle is a car, the storage medium provides a first initial charge to the supercapacitor, and the alternator provides power to the supercapacitor to run the car.

58. The supercapacitor charge method according to claim 45, wherein if the vehicle is a forklift, the charger charges the storage medium, and the storage medium provides power to the supercapacitor to run the forklift.
